(19) United States
(12) Patent Application Publication
(10) Pub. No.: US 2008/0074648 A1
(43) Pub. Date: Mar. 27, 2008

(54) Method and Apparatus for Three-Dimensional Measurement of Objects in an Extended angular range

(75) Inventor: Ralf Lampalzer, Erlangen (DE)

Correspondence Address: LERNER GREENBERG STEMER LLP, P O BOX 2480, HOLLYWOOD, FL, 33022-2480, US

(73) Assignee: 3D-SHAPE GMBH, Erlangen (DE)

(21) Appl. No.: 11/851,093

(22) Filed: Sep. 6, 2007

(30) Foreign Application Priority Data
Sep. 6, 2006 (DE) 102006042311.9

(51) Int. Cl. G01N 21/00

(52) U.S. Cl. 356/73

(57) ABSTRACT

An apparatus and a method are presented which render possible the 3D acquisition of objects (4) with the aid of an optical 3D sensor from an angular range that is larger than that which is yielded by one view, in a short measuring time and without mechanical movement. This end is served by a specific mirror arrangement (3) in combination with a modification of the optical 3D sensor.

### TECHNICAL PROBLEM AND PRIOR ART

In many applications in medicine, technology and art, 3D sensors are used for three-dimensional acquisition of shape. Exemplary problems are: acquiring components in automotive industry, measuring statues. Exemplary medical problems in which living humans or parts of humans are acquired are: 3D acquisition of the head, acquisition of faces, of breasts, backs, feet. Exemplary measuring principles for optical 3D sensors are laser triangulation or coded illumination, for example with strip projection.

As a rule, an optical sensor acquires or measures only from one viewing direction. However, a frequent problem is panoramic measurement of the object, or at least measurement from an angular range which is larger than that resulting from only one view. (“3D wide angle measurement”). This problem is usually solved by recording the object from a number of directions and combining (registering) the various views. The object or the sensor is usually repositioned in this case.

A further requirement is to keep the time required for a measurement sequence as short as possible, and to save the working step of repositioning. Moreover, quick measurement is required when measuring in the medical field because of possible movement of the human—including inadvertent movement.

In the case of many systems, repositioning is therefore performed by motorized movement. The G-Scan system [Fraunhofer 04] of the Fraunhofer-Gesellschaft is used to measure human faces. No repositioning of the sensor or of the object is performed here. Rather, only a “virtual” repositioning of the sensor is performed, by rotating a mirror into four positions sequentially in time and giving rise in each position to a beam path that reaches, with the aid of a respective further mirror, a new virtual position of the sensor in relation to the measurement object (face). One disadvantage of the system is the necessarily sequential cycle of the measurements, and the complicated movement mechanism of the mirrors. Again, folding the mirrors over takes time.

A further requirement in technology and medicine is the measurement of the texture of the surface of objects including the 3D shape.

The object can be achieved partially by modifying the 3D sensor, for example by using color cameras instead of black and white cameras. Color information is also obtained in relation to each measurement pixel. Such a unit is built by 3dMD [3dMD 06] using the stereo method.

There are likewise methods for acquiring the texture which make use of an additional color camera in addition to the sensor. As a rule, the color camera is calibrated photogrammetrically in relation to the sensor coordinate system. The color camera is used to take a picture once the 3D measurement has been performed, or in a pause for changing images. Said picture is projected mathematically onto the 3D data (“mapped”) and the texture is calculated in this way. [contento 05].

### CRITICISM OF THE PRIOR ART

A mechanical movement of the sensor, of the object or of mirrors for 3D wide angle measurement requires too much time for some problems. For example, human faces should be measured in a period less than one second, since inadvertent movements lead to measuring errors. Old people, children, Parkinson's patients, in general people in a poor state of health, in particular, cannot be in a position of rest for long.

Furthermore, by way of example the mirror arrangement of the G-Scan product does not achieve panoramic measurement, but only the measurement of the front half space around the human head. The unit can be used to measure the face, but not to measure a complete head.

Thirdly, the quality of the recorded textures is generally low. The use of color video cameras instead of black and white video cameras is disadvantageous precisely through the use of these color cameras: the resolution (pixel number) of these color video cameras is mediocre, because the latter are optimized simultaneously for outputting images quickly and continuously. The quality of the 3D measurement is impaired.

When the illumination is performed by the (coding) illuminating system of the 3D sensor, this has the disadvantage that this illuminating system is designed for producing a structured illumination, that is to say with a small aperture. It is known from photography that pictures with a small aperture lead to inhomogenities and strong local variations in the observed object brightness, for example through shading and reflections. The problem of “acquiring the object texture in the 3D image” can therefore not be effectively solved, because the object texture should be a property that is as far as possible independent of the illumination, but that depends strongly on the illumination owing to the incomplete measurement.

### DESCRIPTION OF THE INVENTION

The invention is intended to solve the problems described in its preferred design: panoramic measurement without mechanical movement and, in addition, the acquisition with high resolution of a color texture largely independent of illumination. The invention is preferably to be used to measure human heads, faces and other body parts, but it is also possible, of course, to acquire works of art, jewelry or technical objects in three dimensions.

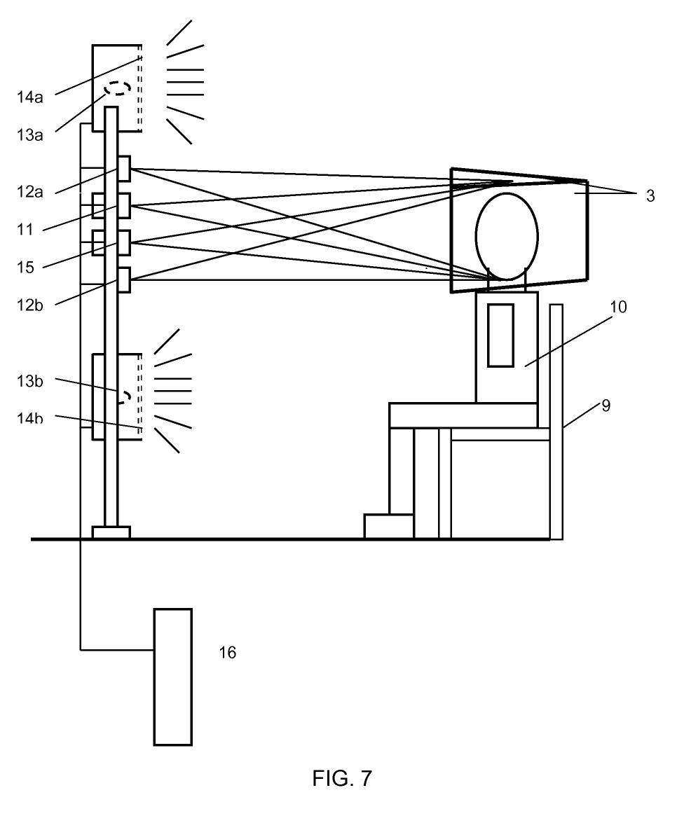

An optical 3D sensor is to be used for measurement; laser triangulation, coded illumination or the stereo method preferably being taken into consideration here. Two of these methods—laser triangulation and coded illumination—exhibit an illuminating system and an observing system that have a common image field. The stereo method exhibits at least two cameras that have a common image field and can be backed up by active illumination with strip projection. The respectively common image field is to be denoted as “image field of the 3D sensor”. An axis which begins in the middle of the triangulation base of the sensor and ends in the middle of the image field of the 3D sensor is to be denoted as “optical axis of the 3D sensor”. The triangulation base is here either the distance between the pupil of the observing system and the pupil of the illuminating system, as illustrated in FIG. 7, for example, the definition is analogous in the case of a number of observing systems and illuminating systems.

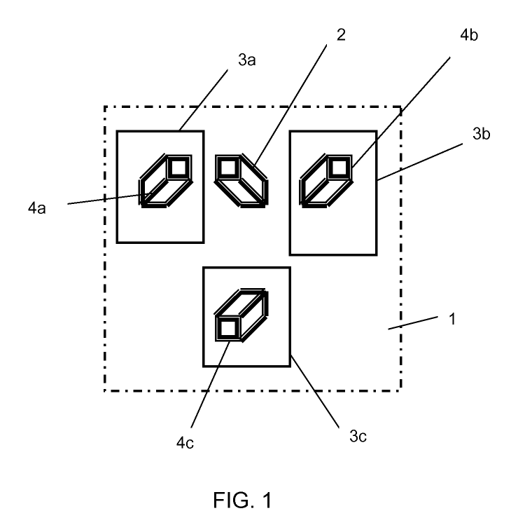

One feature of the invention (FIG. 1) is that the image field (1) of the optical sensor is split. Both the object (2) and a row of mirrors, here (3a), (3b), (3c) for example, are in the image field. At least one mirror is to be used in this case.

The division of the image field renders it possible to position the object (2) in one part of the image field and to place in other parts of the image field mirrors (3a, 3b, 3c) in which other viewing directions of the object are respectively visible from the perspective of the sensor (FIG. 1). In one part of its image field, the sensor can measure a direct 3D view of the object. In other parts of the image field, the sensor can measure virtual mirror images (4a, 4b, 4c) of the object. In this case, the illuminating beam path and the observing beam path of the sensor are to run in each case via the same mirror. The mirror is to be plane. On the basis of the laws of reflection, in this case the sensor measures a metrically correct 3D view of the object from another perspective. This holds for each angle at which the mirror stands, not only, for example, for 90° or 45°. The 3D view is mirror inverted only when an uneven number of reflections have taken place, and this can be corrected in the following evaluation.

Since the position of the mirrors and of the 3D sensor is known, the position of the associated real 3D views can be calculated from the virtual 3D views in each case. These 3D views can be combined with the directly measured 3D view to form a complete 3D object (registration).

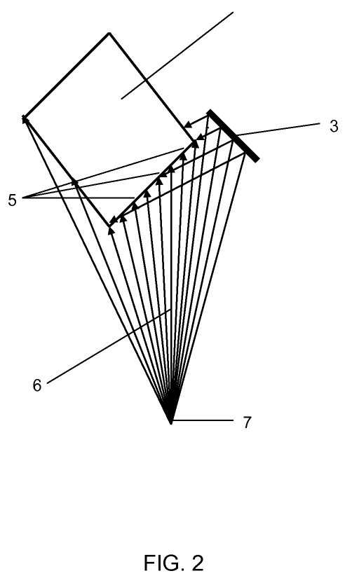

The described procedure leads to a problem that, as demonstrated in FIG. 2, requires an inventive solution. The problem consists in that there can be regions (5) on the object (2) in which a number of regions of the coded illumination (6) or sections of the laser line can be superposed on one another. It can happen that the directly projected illumination is superposed with one or a number of the illuminations reflected via the mirrors, or the illuminations reflected by the mirrors can be superposed on one another.

The solution to this problem is a further feature of the invention. In a simple form of the solution, the superposition is avoided according to the invention in that the measurement is performed in a number of temporally consecutive phases. Only a part of the image field is illuminated in each case in the image field of the illuminating system. In one of the phases, only the part of the image field (1) in which the object (2) is located is illuminated. In other phases, respectively one mirror (3a, 3b, 3c) is illuminated. The other parts of the image field must be switched to dark. As a result, there is in each case only a single optical path from the illumination to the object, and no superpositions of the illumination from various directions comes about.

In order to implement this solution, it is necessary to be able to address the illumination completely in spatial terms. This obtains, for example, when use is made of a video projector. A system with laser triangulation having a light line traced by a scanner mirror can be used when, for example, the reversal points of the scanner movement are varied under control. Another possibility is to switch the light source on and off under control such that only the selected fields of view are respectively illuminated.

The introduction of the described temporally consecutive phases of the measurement certainly lengthens the time required for measurement, but there is no need for mechanical movement between the phases, and so a substantial gain in time continues to remain as inventive advantage.

An acceleration of the measurement is possible with the aid of another inventive solution: two 3D views can respectively be measured simultaneously with the aid of a specific arrangement of the mirrors. This is the case whenever the corresponding parts of the image field of the illuminating system can be switched simultaneously to bright without the object regions illuminated thereby overlapping.

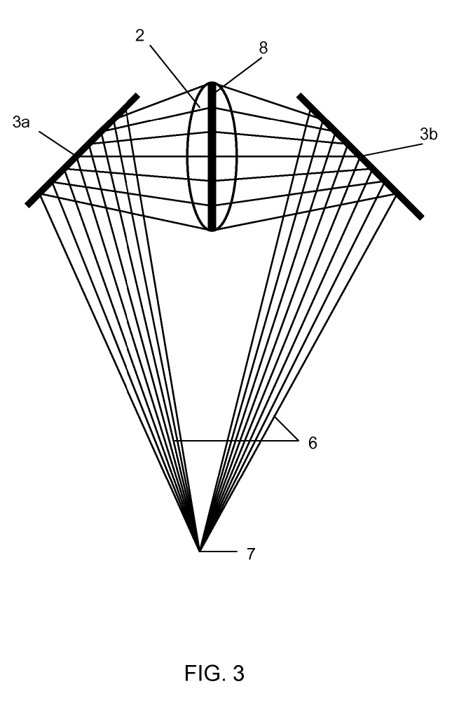

This can be achieved, for example, when both parts of the image field of the illumination are imaged onto the object via a mirror, and the direction vectors of the incident light via these two mirrors oppose one another at an angle of approximately 180°, as shown in FIG. 3. Because of the fact that the illumination emanates from a nodal point (7), it is generally unilluminated zones (8) that are produced, that is to say it is also possible to tolerate small deviations from the 180° angle. Both 3D views are correct when the observing system is now evaluated according to two parts of the image field.

When the sensor is equipped with this feature, measurement thus comprises a phase with direct measurement, at least one phase with simultaneous measurement of two 3D views as described, and possibly further phases of the measurement of individual 3D views via a mirror.

The desired effect that various parts of the object can be simultaneously illuminated and measured can also be achieved in principle by controlling the illuminated fields of view such that they do not overlap one another. This is possible, in particular, when the object and its position are roughly known. It is then also not necessary for the illuminating directions to oppose one another.

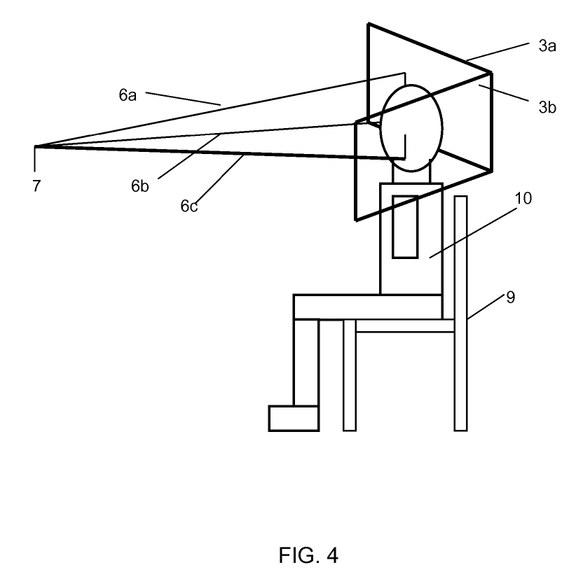

A particular arrangement of the mirrors is illustrated in FIG. 4: two mirrors are arranged such that the direct 3D view yields a frontal view of the object, in this case a human head, and the two 3D views that are measured via the two mirrors respectively yield side views of the object from directions approximately perpendicular to the observing direction of the direct view. As shown in FIG. 4, the mirrors are correspondingly at an angle of approximately 45° to the optical axis of the 3D sensor. Also drawn in FIG. 4 are beams 6a, 6b, 6c that emanate from the nodal point of the illuminating system. The beams lie approximately in a horizontal plane. The beam 6a is directed by the mirror 3a in the direction of the right ear of the object, and the beam 6b is directed by the mirror 3b in the direction of the left ear of the object. The beam 6c illuminates the object directly.

This measuring geometry is well suited to the acquisition of faces, in particular. The face can therefore be acquired in three dimensions inclusive of the sides as far as the ears. A seating facility (9) on which the person (10) to be measured sits can be located below the mirror construction. As described above, measurement via the mirrors can be performed simultaneously. The measurement is therefore performed in a total of two or three phases.

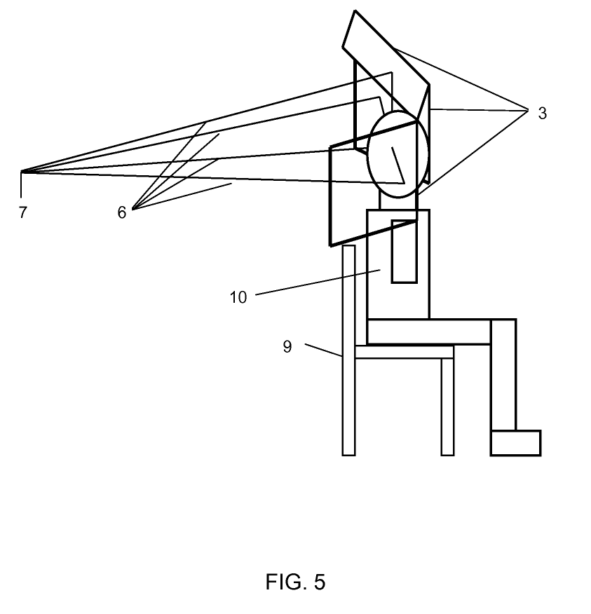

A further particular arrangement of the mirrors is illustrated in FIG. 5. In addition to the mirrors in FIG. 4, a further mirror can be used to provide a further 3D view for a measuring direction perpendicular from above. The measurement is performed in three phases, for example: direct measurement, measurement from the left and right (simultaneously), and measurement from above. It would also be possible to use a further mirror to measure from below simultaneously or sequentially.

This measuring geometry is suitable for acquiring parts of the human head, in particular for example when a helmet is to be fitted. Otherwise than in the case of the design according to FIG. 4, the person is seated here in an opposite direction. The sensor measures the head of the person from behind, above, right and left. Measurement is performed in a total of three or four phases.

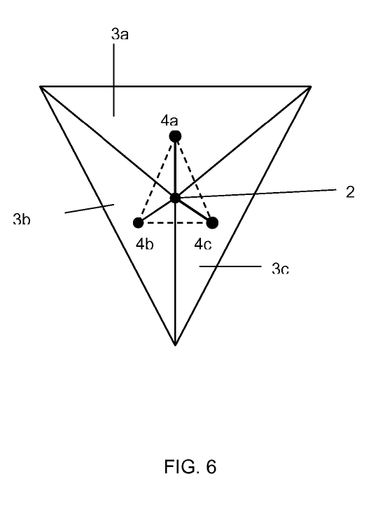

A further particular arrangement of the mirrors is illustrated in FIG. 6. Three mirrors 3a, 3b, 3c are arranged such that the four measuring directions—the direct measuring direction and the three virtual measuring directions via the mirrors—are oriented such that the object (2) is located in the middle of a virtual tetrahedron, and the measurements are performed from the corners of this tetrahedron. FIG. 6 is drawn from the perspective of the direct measuring direction. The observing system sees the direct image of the object (2) and three further virtual mirror images 4a, 4b, 4c.

As is known from the chemistry of the carbon atom, the angle between the measuring directions is approximately 104°. The mirrors are therefore tilted relative to the optical axis of the illumination of the sensor by approximately 52° in accordance with the law of reflection, and positioned azimuthally in a regular 120° arrangement. The arrangement exhibits high symmetry and permits a 3D panoramic measurement with as large an overlap of four 3D views as possible. It is suitable for panoramic measurement of human heads, for example; here, as well, the person is positioned on a seating facility below the mirror construction. Measurement is performed in a total of four phases.

A further embodiment of the invention relates to checking for movement artifacts. When measuring objects that move under some circumstances, such as humans, for example, a suitable algorithm can be used after each phase of measurement to check whether the person being measured has moved too much or the data of this phase of measurement cannot be used for other reasons (for example error function of the 3D sensor). This phase of measurement can then immediately be repeated before the next phase proceeds. For this purpose the partial images of each measurement are checked for known properties as described in [Creath 86], for example.

It is therefore to be expected when operating such measuring apparatus that the position of the mirrors varies slightly in the course of time, for example when a patient bumps against the mirror construction. Such small variations of the mirrors would have the effect that the registration of the 3D views no longer functions exactly in late operation, and that discontinuous transitions will be seen in the data of the 3D wide angle measurement. In order to avoid this problem, after measurement of the 3D views the data needs to be registered during operation of the measuring apparatus, and this registration is integrated into the evaluation in accordance with the invention.

The concept of the mirror construction can be combined with the concept of the rotation of the measurement object. Thus, a measurement object can firstly be measured from a number of directions with the aid of the mirror construction, then rotated or displaced, and then remeasured. The process can be repeated several times. This produces a number of 3D wide angle views which, can be registered relative to one another, and be combined to form a comprehensive 3D wide angle view. This can serve, in particular, for filling up gaps (shading) in the 3D view.

The invention can also be used to record a texture of the object to be measured in addition to the 3D information. Two methods come into consideration in order to implement the advantageous recording of a texture in accordance with the invention.

Firstly, when use is made of an illuminating unit of the 3D sensor with an addressable illumination, this illuminating unit can be enhanced such that it can also illuminate the object in various colors, preferably the three primary colors of red, green and blue. Video projectors are suitable for implementation. The sensor is further equipped with black and white cameras. The method has the advantage that no further hardware is required for texture measurement when use is made of a video projector or another controllable light source.

The hue can be calculated pixel by pixel in a fashion corresponding to the 3D views by projecting the various colors and by recording with the black and white camera. The parts of the image field are assigned to the various 3D views, and thereafter these 3D views are cut apart from one another and registered, as explained.

The illuminating system of the 3D sensor generally has a very small illuminating aperture. According to the invention, the very slight illuminating aperture is additionally increased by the mirror construction in a decisive way, because (additional) virtual images of the illuminating device are produced which exhibit a large angle to the actual illuminating device (synthetic aperture). Texture pictures with a higher illuminating aperture reproduce the texture better than pictures with a low aperture. In particular, the illumination becomes more homogeneous and fewer shadows and highlights are produced. The brightness in the observed image also no longer depends so strongly on the local inclination of the surface element observed.

A further and improved possibility for measuring a texture in combination with the mirror construction consists in positioning an additional color camera (14) in the vicinity of the optical 3D sensor—see FIG. 7.

When the 3D sensor is based on a triangulation method, an advantageous position for accommodating the color camera is a location in the vicinity of the triangulation base of the triangulation sensor, because then the color camera does not further enlarge the angular range of the illuminating and observing beams, and smaller mirrors suffice.

The image field of the color camera is intended to correspond approximately to the image field of the 3D sensor. The color camera can be optimized for recording a single image, not necessarily for recording image sequences. Thus, digital color photographic cameras can be used that can attain a resolution which exceeds the resolution of the 3D measurement video cameras.

In any case, the usual software models for managing textured 3D data envisage the possibility of representing and managing textures that have a higher resolution than the 3D data. According to the prior art, a color digital photographic camera with 12 megapixels is available, for example.

These color photographic cameras further have an optimized system for color rendition with automatic white balance, and can therefore record and reproduce colors better. The position of the color camera and the position of all its observing beams in space must be known, this purpose being served by a camera calibration that is to be carried out.

In this implementation of the invention, according to the invention the illumination for the color recording with the aid of an additional color camera is not, or is not only, intended to be performed by the illuminating system of the 3D sensor (although this is possible), since the aperture thereof is relatively small and the quality of texture measurement can be further improved. This is valid even when the illuminating aperture is increased by the reflection.

The illumination is, moreover, intended to be performed by a separate illuminating system with a high aperture. It is to be preferred for this purpose, or in addition, to use flash systems that flash indirectly, for example via a reflector disk, and to enlarge the aperture in this way. The illuminating aperture is also additionally increased in a decisive way here by the mirror construction. It has been shown in experiments that very good texture measurement is possible through the use of a mirror construction with an aperture of illumination of 5°×5° for color recording.

When the illuminating unit is used, the various views of the measurement object at various points in the image field of the color camera are simultaneously visible, and can at the same time be recorded with a single recording. Thereafter, the views can be extracted individually for evaluation. According to the invention, the individual views are imaged algorithmically in a further method step onto the measured 3D wide angle measurement with the aid of the camera calibration. It is thereby possible to add a texture to the 3D wide angle measurement view with an extended angular range.

Just as in the case of 3D measurement, unavoidable small variations in the mirror construction would lead to a spatially false assignment of the texture on the object surface. The variations in the mirror construction are, however, to be assumed as known after the above described registration of the 3D views relative to the 3D wide angle measurement has taken place. The registration supplies a small correction to the position of the mirrors that can be taken into account in the mathematical imaging of the texture onto the measurement object.

A direct view of the object and, in general, a number of views recorded via mirrors are located in the image field of the color camera. The latter views will appear slightly darker, because the reflection coefficient of the mirror is less than one. An aluminum mirror has a reflection coefficient of approximately 70%. The known numerical value for the reflection coefficient of the mirrors can be used to correct the brightness of the various views.

A particular exemplary embodiment for a 3D as illustrated in a side view in FIG. 7 will now be specified using the above described teaching. The optical 3D sensor specified above comprises the projector (15) and, in this case, two black and white video cameras (12a, 12b). The black and white video cameras and the projector are controlled by a control and evaluation unit (16), and the images of the black and white video camera are evaluated by the control and evaluation unit (16). In the example shown, the triangulation plane is perpendicular to the plane of the drawing, and the connecting line between the two black and white video cameras is the triangulation base. The color camera (11) is located on this triangulation base. The marginal rays of the image fields of the black and white video camera, the color camera and the projector are respectively drawn in. To record the color texture, two flash lamps (13a, 13b) each having a diffusing screen (14a, 14b) are arranged so as to produce a large illuminating aperture. The flash lamps and the color camera are likewise controlled by the control and evaluation unit (16).

### LITERATURE

[contento 05] Product sheet for sensor “3D scanner trio” from Stiefelmayer-Contento GmbH & Co KG, Hüttenweg 4, 97877 Wertheim, Germany, 2005; http://www.stiefelmayer-contento.de/laser/pdf/flyer-lasersysteme-2005.pdf
[Fraunhofer 04] Product sheet for sensor “gscan”, Fraunhofer Institut für angewandte Optik und Feinmechanik [Fraunhofer Institute for Applied Optics and Precision Engineering], Jena, http://www.iof.fhg.de/departments/optical-systems/_media/g-scan_{—}11_{—}2004_d.pdf
[3dMD 06] Website of 3dMD, 100 Galleria Parkway Suite 1070 Atlanta, Ga. 30339, USA http://www.3dmd.com/AboutUs/Technology.asp
[Creath 86] K. Creath, “Comparison of Phase Measurement Algorithms”, Proc. of the SPIE 680(1986)

1-28. (canceled)

29. A method for forming a comprehensive three-dimensional measurement of an object shape, using an optical three-dimensional sensor including an observing device and a controllable illuminating device for measuring a contour map of the object, and at least one mirror, comprising the steps of:
spatially arranging the at least one mirror in at least one field of view of the observing device for measuring a plurality of three-dimensional views of the object, measuring a first of the views by directly observing the object and at least a second of the views by other than directly observing the object;
illuminating the three-dimensional views by the at least one mirror: and
forming a comprehensive three dimensional view of the three-dimensional views as a function of spatial positions of the sensor and the mirrors.

30. The method according to claim 29, including the step of:
sequentially illuminating the at least one mirror by dividing a field of view of illumination to control the observing device.

31. The method according to claim 30, including the step of:
arranging at least one pair of mirrors so that when the mirrors are simultaneously illuminated no part of the object is simultaneously illuminated from more than one direction.

32. The method according to claim 31, including the step of:
arranging at least one pair of mirrors so that illuminating directions of the illumination of the object from the pair of mirrors oppose each other at an angle of substantially 180°.

33. The method according to claim 29, having a plurality of mirrors, including the step of:
arranging the mirrors to produce a frontal view of the object from a direction directly observing the object and side views of the object from directions that are substantially perpendicular to the direction directly observing the object.

34. The method according to claim 33, including the step of:
arranging a further mirror to measure a view from above the object in a direction that is substantially perpendicular to the observing direction of the direct view.

35. The method according to claim 29, having three mirrors, including the steps of:
arranging the mirrors and the sensor so that four measuring directions comprising a direct measuring direction and three virtual measuring directions are oriented so that the object is located in the middle of a tetrahedron configuration; and
performing measurements from corners of the tetrahedron.

36. The method according to claim 29, including the step of:
compensating for errors in the arrangement of the at least one mirror by registering the measured three-dimensional views.

37. The method according to claim 29, including the step of:
rotating and displacing the object to take at least one subsequent measurement of object parts that were not measured in a first measurement.

38. The method according to claim 29, including the steps of:
additionally illuminating sequentially the object with various colors by the controllable illuminating device;
recording variously colored images by the observing device; and
providing from the images three-dimensional views having color texture in pixelwise format.

39. The method according to claim 29, including the steps of:
arranging in the vicinity of the three-dimensional sensor a color camera to acquire a color image and having a field of view that corresponds substantially to a field of view of the three-dimensional sensor;
recording with the color camera color image views in addition to the three-dimensional views, wherein the color image views are simultaneously visible at various points in the field of view of the color camera and are recorded and thereafter extracted individually for evaluation; and
algorithmically imaging the color image views onto a measured three-dimensional wide angle measurement as a function of known positions of the color camera, mirrors and sensor, to produce a comprehensive three-dimensional measurement of the object shape with texture.

40. The method according to claim 39, including the steps of:
illuminating the object from a solid angle of at least 5°×5°; and
enlarging the solid angle of illumination to produce texture for the measurement.

41. The method according to claim 36, including the step of:
correcting possible deviations from a geometry of the sensor to produce a color texture.

42. The method according to claim 38, including the step of:
using a reflection coefficient of the mirrors when calculating texture to avoid texture discontinuities at boundaries of color image views.

43. The method according to claim 29, including the step of:
automatically checking the measurement of the three-dimensional views for errors;
and repeating the measurement if an error is identified.

44. The method according to claim 29, wherein the object is a human part.

45. An apparatus for comprehensive three-dimensional measurement of an object shape, comprising:
an optical three-dimensional sensor having an observing device, and a controllable illuminating device and at least one mirror for measuring a contour map of the object shape, and a control and evaluation unit,
said at least one mirror being arranged spatially in a field of view of said observing device for measuring a plurality of three-dimensional views of the object shape, at least one of said three-dimensional views being by directly observing the object shape and at least another of the three-dimensional views being by observing the object shape by said at least one mirror; and
said control and evaluation unit controlling said sensor so that said at least one mirror illuminates certain of the three-dimensional views being performed, said control and evaluation unit registering certain of the three-dimensional views to form a three-dimensional wide angle measurement as a function of spatial positions of said sensor and said at least one mirror.

46. The apparatus according to claim 45, wherein said control and evaluation unit sequentially illuminates mirrors by controlled division of a field of view.

47. The apparatus according to claim 46, wherein at least a first pair of mirrors is arranged so that in the case of simultaneous illumination by said mirrors no point in the object is simultaneously illuminated from a number of directions.

48. The apparatus according to claim 47, wherein said at least first pair of mirrors is arranged such that the illuminating directions from which the illuminating unit illuminates the object oppose each another at an angle of substantially 180°.

49. The apparatus according to claim 45, comprising two mirrors arranged to provide a direct three-dimensional frontal view of the object shape and to provide two three-dimensional side views of the object shape, and directions of the side views and the direct view are substantially perpendicular.

50. The apparatus according to claim 49, comprising a further mirror that is arranged to measure a view from above the object having a direction substantially perpendicular to the observing direction of the direct view.

51. The apparatus according to claim 45, comprising three mirrors that are arranged to provide four measuring directions including a direct measuring direction and three virtual measuring directions that are oriented in a configuration of a tetrahedron, and the object is located in the middle of the tetrahedron, and measurements are performed from the corners of the tetrahedron.

52. The apparatus of in claim 45, comprising: an additional displacing device for the object, wherein said control and evaluation unit moves the displacing device after a measurement to perform a subsequent three-dimensional measurement of object parts that are not measured in a first measurement.

53. The apparatus according to claim 45, wherein: said control and evaluation unit additionally controls said illuminating device to illuminate the object sequentially with various colors, said control and evaluation unit controls the observing device to record variously colored images, and said control and evaluation unit calculates a color texture in pixel format relating to the three-dimensional views.

54. The apparatus according to claims 45, comprising: a color camera arranged in the vicinity of said three-dimensional sensor to acquire a color image and having a field of view that substantially corresponds to the field of view of said three-dimensional sensor, said control and evaluation unit controls said color camera to record color image views in at least a direct observation path in addition to the three-dimensional views, such that the various color image views are simultaneously visible at various points in the field of view of said color camera, and said control and evaluation unit controls said color camera to record the color image views, and said control and evaluation unit extracts the recorded color image views individually for evaluation, and said control and evaluation unit images the color image views onto a comprehensive three-dimensional view of the texture of the object as a function of position of said color camera, mirrors and sensor.

55. The apparatus according to claim 54, comprising: at least one illuminating system of large aperture to illuminate the object from a solid angle of at least 5°×5° and said mirrors arranged to enlarge the solid angle of the illumination.

56. The apparatus according to claim 45, wherein the object is a human part.
